(19) United States
(12) Patent Application Publication
(10) Pub. No.: US 2010/0005131 A1
(43) Pub. Date: Jan. 7, 2010

(54) Power-residue calculating unit and method of controlling the same

(75) Inventor: Hiroshi Fukazawa, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/213,319

(22) Filed: Jun. 18, 2008

(30) Foreign Application Priority Data
Jun. 29, 2007 (JP) 2007-171831

(51) Int. Cl. G06F 7/72; G06F 7/52

(52) U.S. Cl. 708/491; 708/606; 708/625

(57) ABSTRACT

A power-residue calculating unit according to one embodiment of the present invention includes a multiplication residue calculating unit performing a multiplication calculation and a residue calculation based on a multiplicand, a multiplier, and a divisor, a power storing portion separately storing value of each bit when a power is shown by a binary number, a first selecting circuit outputting one of an output of the multiplication residue calculating unit and the multiplicand depending on the value of the bit that is referred, and a result storing register storing an output value of the first selecting circuit as a calculation result.

### BACKGROUND OF THE INVENTION

1. Field of the Invention

The present invention relates to a power-residue calculating unit and a method of controlling the same, and more particularly, to a power-residue calculating unit having a tamper-resistant function and a method of controlling the same.

2. Description of Related Art

Hitherto, a credit card with a built-in IC chip has widely been used. The IC chip typically stores card information or personal information or the like. The information stored in the IC chip needs to be protected from leakage or manipulation. Such an information protection function is called tamper-resistant function, and information protection ability is called tamper resistance.

An encryption method using an RSA (Rivest Shamir Adleman scheme) encryption method or the like has generally been performed on the information stored in the IC chip in order to keep the information secret. Then the information is stored in the IC chip with being encrypted, and is decrypted when it is read out. In the encryption method such as the RSA encryption method that has been currently employed, an algorithm of the encryption is released, and its safety is fully examined. However, safety in a case where this algorithm is implemented in a hardware or a software has not been studied enough since the security largely depends on its implementation method. For example, there is a side channel attack as a method of obtaining secret information by exploiting vulnerabilities of the implemented algorithm.

The side channel attack is a method of introducing secret information from other path than an original communication path (generally called channel). For example, information stored inside is introduced from side channel information such as process time, electromagnetic wave or electric power consumption of the IC chip executing encryption or decryption of the information. A method of introducing the information from a waveform of the electric power consumption is called SPA (Simple Power Analysis), and a method of determining a difference of a calculation content by statistically processing a difference of the electric power consumption is called DPA (Differential Power Analysis). A method of focusing on a change of the process time of the calculation is called timing attack.

Now, the calculation of the encryption and the decryption used in the RSA encryption method will be described in brief. In the RSA encryption method, the encryption is performed based on the expression (1), and the decryption is performed based on the expression (2).

C=M^{E} modN (1)

M=C^{D} modN (2)

In the expressions (1) and (2), C represents a ciphertext, M represents a plaintext, E and N represent public keys, and D represents a secret key.

In summary, in the RSA encryption method, it is possible to perform the encryption and the decryption by the same power-residue calculation. Accordingly, if powers E and D are represented by D, the plaintext M in the encryption by X, the ciphertext C in the encryption by Y, the ciphertext C in the decryption by X, and the plaintext M in the decryption by Y, then the calculation of the RSA encryption method can be expressed by the following expression (3).

Y=X^{D} modN (3)

The calculating unit executing the calculation expressed by the expression (3) is hereinafter referred to as power-residue calculating unit.

Now, a method of realizing the calculation shown in the expression (3) by using a value expressed by a binary number will be described. Here, the power is indicated by the binary number. A method of performing the power-residue calculation shown by the expression (3) by performing a square calculation when the bit value indicating the power is “0” and performing the square calculation and a multiplication when the bit value indicating the power is “1” is called a binary method. When the binary method is used, the expression (3) can be realized by repeating the calculation of A×BmodN. The calculation algorithm of the RSA encryption method using the binary method is shown as follows.

Y=1 . . . (4)
for(j=1024 to 1) . . . (5)

Y=Y×YmodN . . . (6)
if(d[j]==1) then Y=Y×XmodN . . . (7)

end for

d[j] is a j-th bit value of the power D.

According to the above algorithm, if the power D is 57, for example, the power D can be expressed as “111001” in the binary number. Accordingly, in the calculation of upper 3 bits including a most significant bit, calculations of the expressions (6) and (7) are performed. However, since fourth and fifth bits from the most significant bit are “0”, only the calculation of the expression (6) is performed.

Accordingly, when the RSA encryption method is implemented in the IC chip using the binary method, since the calculation method is different depending on values of the power D, the timing attack or the side channel attack such as the SPA or the DPA may be executed based on the difference.

A technique for improving a tamper resistance against the side channel attack is disclosed in Japanese Unexamined Patent Application Publication Nos. 2004-125891 (hereinafter referred to as related example 1) and 2001-195555 (hereinafter referred to as related example 2). FIG. 4 shows a block diagram of the power-residue calculating unit disclosed in the related example 1. In the related example 1, when the value of the power D is d[j]=0, the calculation of the expression (7) is performed as a dummy calculation, thereby eliminating the difference of the electric power consumption and the timing due to the difference of calculation. Further, in the related example 1, a K register 132 is provided for storing a dummy calculation result, and the dummy calculation result is written into the K register 132. Accordingly, in the related example 1, the difference of the electric power consumption caused by writing into the register can be reduced while setting the calculation result in d[j]=0 same as in a case where the expression (7) is not performed. In other words, the power-residue calculating unit of the related example 1 performs writing into the dummy calculation and the dummy register (K register 132) when the value of the power is “0”, so as to reduce the difference of the calculation time or electric power consumption due to the value of the power and to improve the tamper resistance against the side channel attack.

In the technique disclosed in the related example 2, the dummy calculation is executed when the value of the power is “0”. Then the calculation result is discarded or written into the dummy register. In summary, also in the related example 2 as well as in the related example 1, it is possible to reduce the difference of the calculation time and the electric power consumption due to the value of the power and to improve the tamper resistance against the side channel attack.

However, in the methods in the related examples 1 and 2, there is a need to provide a dummy register storing the dummy calculation result, which increases the circuit size. In the recent RSA encryption method, 1024 bits to 2048 bits are typically used as information of the public key and the secret key. Therefore, the dummy register having 1024 to 2048 bits is needed depending on the size of the key. Confidentiality of the information depends on the number of bits of the key. Therefore, when the confidentiality of the information is to be improved, the number of bits of the key and the size of the dummy register further increase. Hence, an influence given to the circuit size by the size of the dummy register further increases along with the improvement of the confidentiality.

### SUMMARY

A power-residue calculating unit according to one aspect of the present invention includes a multiplication residue calculating unit performing a multiplication calculation and a residue calculation based on a multiplicand, a multiplier, and a divisor, a power storing portion separately storing value of each bit when a power is shown by a binary number, a first selecting circuit outputting one of an output of the multiplication residue calculating unit and the multiplicand depending on the value of the bit that is referred, and a result storing register storing an output value of the first selecting circuit as a calculation result.

A method of controlling a power-residue calculating unit according to another aspect of the present invention includes separately storing value of each bit when a power is shown by a binary number, performing a multiplication calculation and a residue calculation based on a multiplicand, a multiplier, and a divisor, and storing one of an output of the multiplication residue calculating unit and the multiplicand in a result storing register as a calculation result depending on the value of the bit that is referred.

According to the power-residue calculating unit of the present invention, one of the output of the multiplication residue calculating unit and the multiplicand is stored in the result storing register in accordance with the value of the bit that is being referred among bits indicating the power. Accordingly, even when the calculation performed by the multiplication residue calculating unit is discarded, it is possible to write the multiplicand into the result storing register. In other words, even when a dummy calculation is performed by the multiplication residue calculating unit, the power-residue calculating unit according to the present invention can keep a consistency of the calculation by discarding the result and writing the multiplicand into the result storing register. Further, according to the power-residue calculating unit of the present invention, it is possible to keep electric power consumption and calculation time substantially constant regardless of the value of the power by performing dummy calculation and writing of the result storing register.

According to the power-residue calculating unit of the present invention, it is possible to improve the tamper resistance while suppressing the increase of the circuit size.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram of a power-residue calculating unit according to a first embodiment;

FIG. 2 is a flow chart showing an operation of the power-residue calculating unit according to the first embodiment;

FIG. 3 is a block diagram of a power-residue calculating unit according to a second embodiment; and

FIG. 4 is a block diagram of a power-residue calculating unit according to a related example 1.

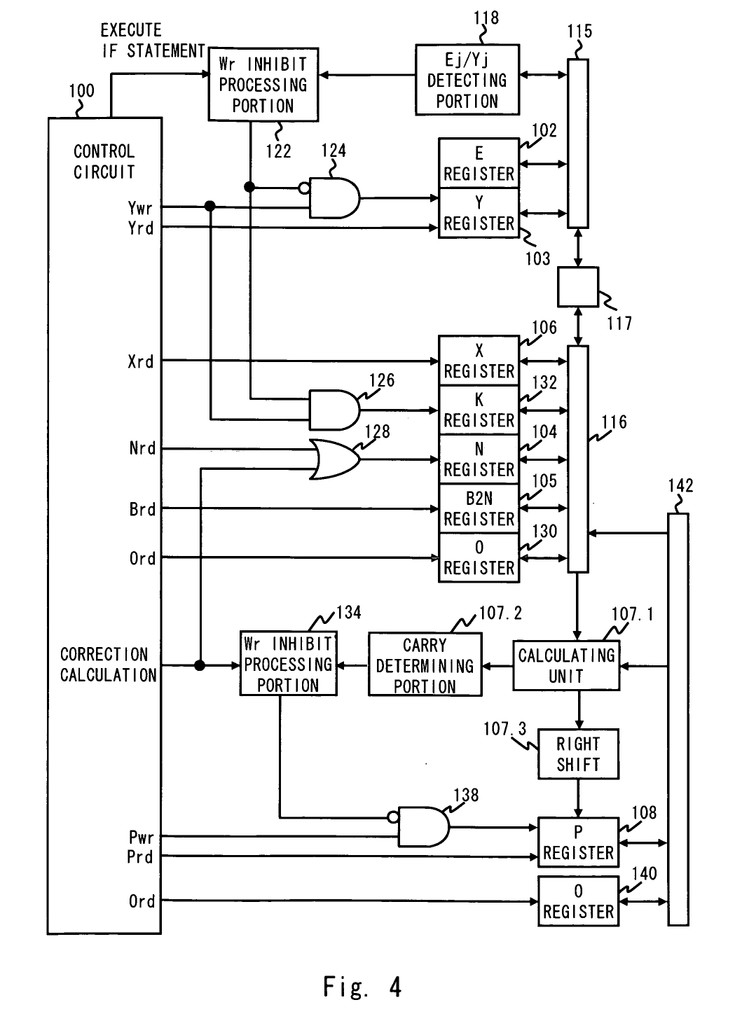

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

A power-residue calculating unit according to the present invention is a calculation unit performing a power-residue calculation used in an RSA encryption method. In the following description, the RSA encryption method including a power of 1024 bits will be described as an example. The power-residue calculating unit according to the present invention repeatedly performs calculation in accordance with a bit length of a power when the value of the power is expressed by a binary number to obtain a calculation result in the expression (8). In the expression (8), X represents a plaintext M in an encryption and a ciphertext C in a decryption, Y represents a ciphertext C in the encryption and a plaintext M in the decryption, D is a power and represents a public key in the encryption and a secret key in the decryption, and N is a public key.

Y=X^{D} modN (8)

If the power is indicated by 1024 bits, the power-residue calculating unit according to the present invention operates based on the following algorithm.

Y=1 . . . (9)
for(j=1024 to 1) . . . (10)

Y=Y×YmodN . . . (11)
if (d[j]==1) then Y=Y×XmodN . . . (12)

end for

Note that d[j] represents a j-th bit value of the power D.

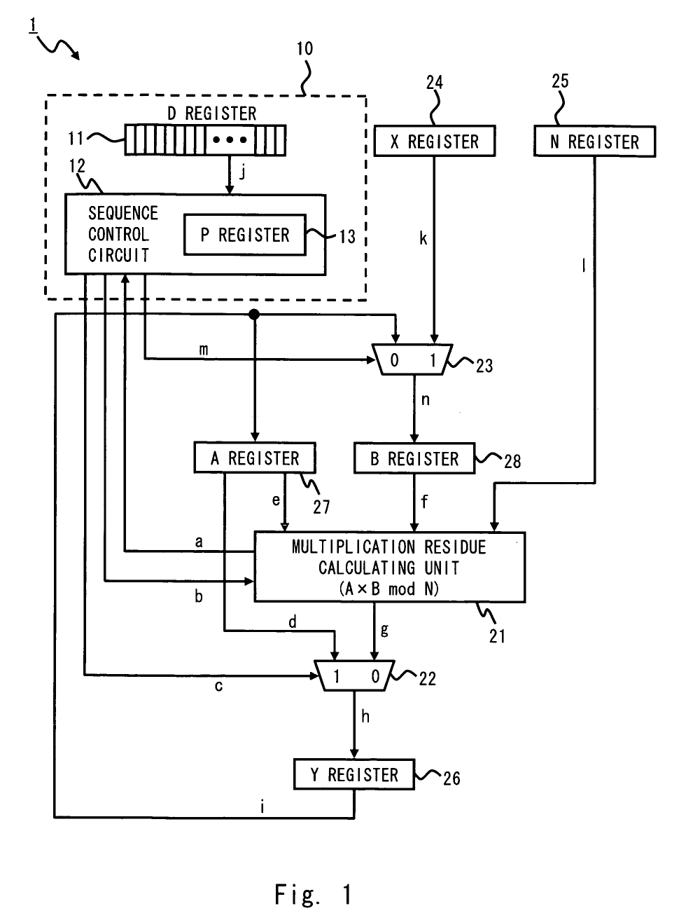

Now, the embodiments of the present invention will be described in detail with reference to the drawings. FIG. 1 shows a block diagram of a power-residue calculating unit 1 according to the first embodiment. As shown in FIG. 1, the power-residue calculating unit 1 includes a control circuit 10, a multiplication residue calculating unit 21, a first selecting circuit 22, a second selecting circuit 23, an X register 24, an N register 25, a result storing register (Y register, for example) 26, a first intermediate register (A register, for example) 27, and a second intermediate register (B register, for example) 28.

The X register 24 stores a value of X in the expression (8), and the stored value is output as a signal k. The N register 25 stores a divisor (a value of N in the expression (8), for example), and the stored value is output as a signal l. The Y register 26 stores a value of Y in the expression (8), and the stored value is output as a signal i. The A register 27 receives a multiplicand (for example, the value obtained by copying a calculation result of a preceding period stored in the Y register 26) as the signal i, and stores the signal i. The value stored in the A register 27 is output as a signal a and a signal e. The B register 28 stores a multiplier (a value output by the second selecting circuit 23 as a signal n, for example), and the stored value is output as a signal f.

The first selecting circuit 22 selects one of a signal d output from the A register 27 and a signal g output from the multiplication residue calculating unit 21 in accordance with the value of a dummy calculation signal c output from the control circuit 10 and outputs the selected signal. To be more specific, the first selecting circuit 22 selects one of the calculation result of the preceding period stored in the A register 27 and the calculation result of the multiplication residue calculating unit 21 in accordance with the value of the dummy calculation signal c to output the selected signal. When the dummy calculation signal c is “1”, for example, the first selecting circuit 22 selects the signal d and outputs the calculation result of the preceding period stored in the A register 27. On the other hand, when the dummy calculation signal c is “0”, then the first selecting circuit 22 selects the signal g and outputs the calculation result of the multiplication residue calculating unit 21. Note that the output of the first selecting circuit 22 is output as a signal h.

The second selecting circuit 23 selects one of the signal k and the signal i in accordance with a calculation selecting signal m output from the control circuit 10 and outputs the selected signal. To be more specific, the second selecting circuit 23 selects one of the X value and the Y value in the expression (8) in accordance with the calculation selecting signal m to output the selected signal. For example, when the calculation selecting signal m is “1”, then the second selecting circuit 23 selects the signal k and outputs a new input value (X, for example) stored in the X register 24. On the other hand, when the calculation selecting signal m is “0”, then the second selecting circuit 23 selects the signal i and outputs the calculation result (Y, for example) of the preceding period stored in the Y register 26. Note that the output of the second selecting circuit 23 is output as a signal n.

The multiplication residue calculating unit 21 calculates a residue obtained by dividing a result of multiplying the multiplicand stored in the A register 27 by the multiplier stored in the B register 28 by the divisor stored in the N register 25. To be more specific, when the calculation result of the preceding period given as the signal i is stored in the B register 28, then the multiplication residue calculating unit 21 calculates Y×YmodN in the expression (11). When the new input value of the signal k is stored in the B register 28, then the multiplication residue calculating unit 21 calculates Y×XmodN in the expression (12). In the following description, the calculation of the multiplication residue calculating unit 21 when Y (the calculation result of the preceding period) is stored in the B register 28 is called first calculation, and the calculation of the multiplication residue calculating unit 21 when X (new input value) is stored in the B register 28 is called second calculation. The calculation result of the multiplication residue calculating unit 21 is output to the first selecting circuit 22 as a signal g. Further, the multiplication residue calculating unit 21 executes calculation when the calculation starting signal b output from the control circuit 10 is “1”. Upon completion of calculation, the multiplication residue calculating unit 21 notifies the control circuit that the calculation has been completed as an operation status signal a.

The control circuit 10 includes a power storing portion (D register, for example) 11 and a sequence control circuit 12. The D register 11 includes a plurality of power storing registers. Each of the plurality of power storing registers stores the value of each bit obtained by expressing the power by the binary number. Further, the sequence control circuit 12 includes a P register 13. The P register 13 stores a count value for checking which bit of the D register 11 is referred to by the sequence control circuit 12. If the D register 11 has 1024 bits, for example, the P register needs to store count value of 10 bits.

The sequence control circuit 12 switches the value of the calculation starting signal b to instruct the multiplication residue calculating unit 21 to start calculation. At the same time, the sequence control circuit 12 receives the operation status signal a from the multiplication residue calculating unit 21 so as to transmit and receive progress information of the calculation to and from the multiplication residue calculating unit 21. Alternatively, the sequence control circuit 12 switches the value of the calculation selecting signal m based on the progress information so that the multiplication residue calculating unit 21 alternately executes the first calculation and the second calculation. Further, the sequence control circuit 12 successively refers to the D register 11, and switches the value of the dummy calculation signal c based on the value of the D register 11 that is referred.

The sequence control circuit 12 controls the calculation selecting signal m and the dummy calculation signal c as follows, for example. The calculation selecting signal m is “0” while the first calculation is performed, and “1” while the second calculation is performed. When the multiplication residue calculating unit 21 performs the first calculation, the dummy calculation signal c is “0” regardless of the value of the D register 11 that is being referred. On the other hand, when the multiplication residue calculating unit 21 performs the second calculation, the dummy calculation signal c is “0” if the value of the D register 11 that is being referred to is “1”, and “1” if the value of the D register 11 is “0”.

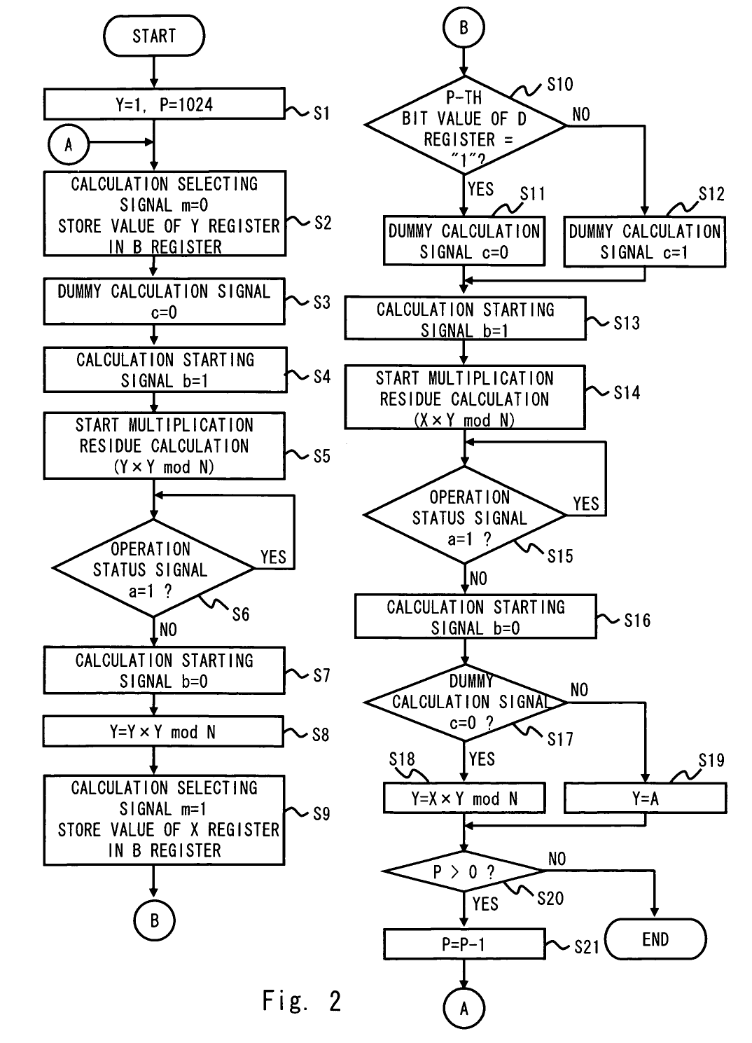

FIG. 2 shows a flow chart showing an operation of the power-residue calculating unit 1. The operation of the power-residue calculating unit 1 will be described with reference to FIG. 2. The power-residue calculating unit 1 sets the value stored in the Y register 26 as 1, and sets the value stored in the P register 13 as 1024 as an initial state of the calculation (step S1). Although not shown, the X register 24 stores the new input value X used for the calculation, and the N register stores the divisor N used for the calculation.

In step S2, the control circuit 10 sets the calculation selecting signal m to “0”. Therefore, the second selecting circuit 23 selects and outputs the signal i. Accordingly, the B register 28 stores the value stored in the Y register 26, and the A register 27 stores the value stored in the Y register 26.

When the values are stored in the A register 27 and the B register 28, the control circuit 10 sets the dummy calculation signal c to “0” (step S3) and sets the calculation starting signal b to “1” (step S4). Since the calculation starting signal b is “1”, the multiplication residue calculating unit 21 starts the calculation (step S5). In the step S5, the multiplication residue calculating unit 21 calculates Y×YmodN. In summary, the calculation executed by the multiplication residue calculating unit 21 in the step S5 is the first calculation. Then the multiplication residue calculating unit 21 holds the operation status signal a as “1” until completion of the calculation (step S6).

Upon completion of the calculation in the multiplication residue calculating unit 21, the operation status signal a is “0”, and the control circuit 10 sets the calculation starting signal b to “0” (step S7). Since the dummy calculation signal c is “0” in the step S3, the first selecting circuit 22 selects the signal g output from the multiplication residue calculating unit 21. Accordingly, the Y register 26 stores the calculation result of the multiplication residue calculating unit 21, which is expressed by Y=Y×YmodN (step S8). The steps S2 to S8 correspond to the processing regarding the first calculation.

Then the control circuit 10 sets the calculation selecting signal m to “1”. Accordingly, the second selecting circuit 23 selects the signal k, and the B register 28 stores the new input value X stored in the X register 24 (step S9). At this time, the A register 27 stores the copy of the value stored in the Y register 26 in the step S8.

Then the control circuit 10 refers to the value of the bit stored in P-th bit of the D register 11 (step S10). When the value of the bit referred in the step S10 is “1”, then the control circuit 10 sets the dummy calculation signal c to “0” (step S11). On the other hand, when the value of the bit referred in the step S10 is “0”, then the control circuit 10 sets the dummy calculation signal c to “1” (step S12).

After determining the value of the dummy calculation signal c, the control circuit 10 sets the value of the calculation starting signal b to “1” (step S13). Since the value of the calculation starting signal b is set to “1” in the step S13, the multiplication residue calculating unit 21 starts the calculation (step S14). The calculation executed in the step S14 is Y×XmodN. In summary, the calculation executed by the multiplication residue calculating unit 21 in the step S14 corresponds to the second calculation. The multiplication residue calculating unit 21 holds the operation status signal a as “1” until completion of the calculation (step S15).

Upon completion of the calculation in the multiplication residue calculating unit 21, the operation status signal a is “0”, and the control circuit 10 sets the calculation starting signal b to “0” (step S16). When the dummy calculation signal c is set to “0” in the step S11, the first selecting circuit 22 selects the signal g output from the multiplication residue calculating unit 21. Accordingly, the Y register 26 stores the calculation result of the multiplication residue calculating unit 21, which is expressed by Y=Y×XmodN (step S18). On the other hand, when the dummy calculation signal c is set to “1” in the step S12, the first selecting circuit 22 selects the signal d output from the A register 27. Accordingly, the calculation result (the value stored in the Y register 26 in the step S8, for example) of the preceding period stored in the A register 27 is written back to the Y register 26, which is expressed by Y=Y×YmodN (step S19). The steps S9 to S18 (or step S19) correspond to the second calculation.

Then the value stored in the P register 13 is determined (step S20). If the value stored in the P register is larger than “0” in the step S20, one is subtracted from the value stored in the P register 13 and the process goes back to the step S2 (step S21). On the other hand, when the value of the P register is “0” in the step S20, the power-residue calculating unit 1 completes the calculation. In other words, the power-residue calculating unit 1 repeats the first calculation and the second calculation depending on the bit length of the value indicating the power. Then after performing the second calculation, the power-residue calculating unit 1 determines depending on the value of the bit that is being referred whether the result of the second calculation is stored in the Y register 26 or the value of the Y register 26 of the preceding period is written back again.

From the above description, the power-residue calculating unit 1 according to the present embodiment switches between the state where the calculation result of the preceding period is written back into the Y register 26 and the state where the calculation result of the multiplication residue calculating unit 21 is written back into the Y register 26 by controlling the first selecting circuit 22 depending on the value of the bit referred to by the control circuit 10. More specifically, the power-residue calculating unit 1 writes the calculation result of the multiplication residue calculating unit 21 into the Y register 26 when the value of the bit that is being referred is 1. On the other hand, when the value of the bit that is referred is “0”, then the power-residue calculating unit 1 discards the calculation result of the multiplication residue calculating unit 21 and writes back the calculation result of the preceding period into the Y register 26. Accordingly, the power-residue calculating unit 1 is able to keep the consistency of the value stored in the Y register 26 after the dummy calculation by writing the calculation result of the preceding period into the Y register 26 even when the calculation performed in the second calculation is the dummy calculation. Then the power-residue calculating unit 1 generates electric power consumption in writing into the Y register after the dummy calculation, and decreases the difference of electric power consumption between the case where the dummy calculation is performed and the case where it is not performed. Since the power-residue calculating unit 1 performs the second calculation regardless of the value of the bit that is referred, the calculation time and the difference of the electric power consumption due to the difference of the value of the power can be reduced. Accordingly, the power-residue calculating unit 1 can keep the calculation time and the electric power consumption substantially constant regardless of the calculation, whereby high tamper resistance can be realized.

In discarding the result of the second calculation, the power-residue calculating unit 1 writes back the calculation result of the preceding period into the Y register 26 in place of the calculation result of the multiplication residue calculating unit 21. Therefore, there is no need to provide dummy register in which the result of the dummy calculation is written. In summary, the power-residue calculating unit 1 realizes the consistency of the calculation and the improvement of the tamper resistance without providing dummy register. Accordingly, by providing the power-residue calculating unit 1 of the present invention, it is possible to decrease the circuit size while securing the high tamper resistance.

### Second Embodiment

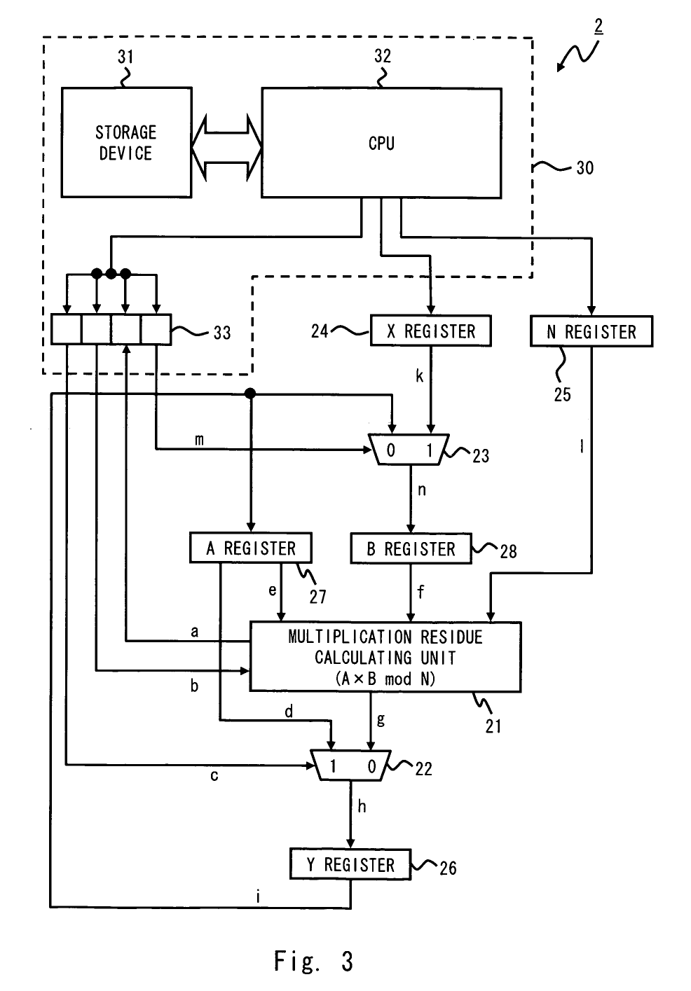

FIG. 3 shows a block diagram of a power-residue calculating unit 2 according to the second embodiment. As shown in FIG. 3, the power-residue calculating unit 2 includes a control circuit 30 in place of the control circuit 10. In the power-residue calculating unit 2, configurations of other parts than the control circuit 30 are the same as those of the power-residue calculating unit 1, and therefore the overlapping description will be omitted.

The control circuit 30 includes a storage device 31, a central processing unit (CPU) 32, and an operation setting register 33. The control circuit 30 controls the multiplication residue calculating unit 21, the first selecting circuit 22, and the second selecting circuit 23 based on the result of executing the program stored in the storage device 31 by the CPU 32. In the present embodiment, the expression used in calculation is defined by a program, and the CPU 32 stores the value in each of the X register 24 and the N register 25 based on the program. The power used in the calculation is defined on the program, and the power is stored in the storage device 31 as the value of the binary number. In other words, the storage device 31 functions as the power storing portion. Then the CPU 32 successively refers to the value of the bit indicating the power stored in the storage device 31 and controls the first selecting circuit 22.

In controlling the multiplication residue calculating unit 21, the first selecting circuit 22, and the second selecting circuit 23, the control circuit 30 stores the value for control in the operation setting register 33. Then the multiplication residue calculating unit 21, the first selecting circuit 22, and the second selecting circuit 23 operate based on the value stored in the operation setting register 33. Note that the registers referred to by the multiplication residue calculating unit 21, the first selecting circuit 22, and the second selecting circuit 23 are separately defined in the operation setting register 33.

From the above description, it can be understood that the power-residue calculating unit 2 shows another embodiment of the control circuit and performs the same operation as that of the first embodiment, whereby high tamper resistance can be realized. When the system includes the storage device 31 and the CPU 32, the power-residue calculating unit 2 uses the storage device 31 and the CPU 32 as the control circuit, which means the control circuit 10 in the power-residue calculating unit 1 is not needed. Accordingly, the power-residue calculating unit 2 is able to further reduce the circuit size compared with the power-residue calculating unit 1.

It is apparent that the present invention is not limited to the above embodiments, but may be modified and changed without departing from the scope and spirit of the invention. For example, instead of separately providing the X register 24, the N register 25, the Y register 26, the A register 27, and the B register 28, these registers may be integrally formed so that it includes a plurality of areas in accordance with the values that are stored.

What is claimed is:

1. A power-residue calculating unit comprising:
a multiplication residue calculating unit performing a multiplication calculation and a residue calculation based on a multiplicand, a multiplier, and a divisor;
a power storing portion separately storing value of each bit when a power is shown by a binary number;
a first selecting circuit outputting one of an output of the multiplication residue calculating unit and the multiplicand depending on the value of the bit that is referred; and
a result storing register storing an output value of the first selecting circuit as a calculation result.

2. The power-residue calculating unit according to claim 1, wherein the multiplication residue calculating unit alternately performs a first calculation and a second calculation, the first calculation using the calculation result of a preceding period stored in the result storing register as the multiplicand and the multiplier, and the second calculation using the calculation result of a preceding period stored in the result storing register as the multiplicand and using an input value newly input as the multiplier.

3. The power-residue calculating unit according to claim 1, wherein the power-residue calculating unit comprises a control circuit referring to the value of the bit and generating a first selecting signal designating which value the first selecting circuit selects.

4. The power-residue calculating unit according to claim 3, wherein the control circuit comprises the power storing portion and a sequence control circuit successively referring to the value of the bit of the power storing portion and outputting the first selecting signal.

5. The power-residue calculating unit according to claim 3, wherein the control circuit comprises a storage device functioning as the power storing portion and in which a program is stored, a setting register in which a value of a first reference value referred to as a value of the first selecting signal is stored, and a central processing unit outputting a value stored in the setting register based on the program.

6. The power-residue calculating unit according to claim 2, further comprising a second selecting circuit outputting the calculation result of a preceding period to the multiplication residue calculating unit as the multiplier in the first calculation, and outputting the input value to the multiplication residue calculating unit as the multiplier in the second calculation.

7. The power-residue calculating unit according to claim 6, further comprising a control circuit generating a second selecting signal designating which value the second selecting circuit selects based on progress information of the calculation.

8. The power-residue calculating unit according to claim 7, wherein the control circuit comprises a storage device functioning as the power storing portion and in which a program is stored, a setting register in which a value of a second reference value referred to as a value of the second selecting signal is stored, and a central processing unit outputting a value stored in the setting register based on the program.

9. The power-residue calculating unit according to claim 1, further comprising a first intermediate register storing the multiplicand, and a second intermediate register storing the multiplier.

10. A method of controlling a power-residue calculating unit, the method comprising:
separately storing value of each bit when a power is shown by a binary number;
performing a multiplication calculation and a residue calculation based on a multiplicand, a multiplier, and a divisor; and
storing one of an output of the multiplication residue calculating unit and the multiplicand in a result storing register as a calculation result depending on the value of the bit that is referred.
